(19) United States
(12) Patent Application Publication
(10) Pub. No.: US 2012/0263880 A1
(43) Pub. Date: Oct. 18, 2012

(54) METHOD FOR MAKING BOUNCING BALL WITH COLUMNS

(76) Inventor: Chia-Yen Lin, Dongguan City (CN)

(21) Appl. No.: 13/085,464

(22) Filed: Apr. 12, 2011

(51) Int. Cl. B05D 3/12

(52) U.S. Cl. 427/355

(57) ABSTRACT

A method for making a bouncing ball with columns is provided. The method includes the steps of: providing a mold comprising an upper mold and a lower mold each having a plurality of column holes extending outward from an inner surface thereof and being communicated with an outside of the mold, wherein an air-permeable and liquid non-permeable material is coated on an outer surface of the mold and thus covers the column holes; filling a ball material into the upper mold or the lower mold, coupling the upper mold and the lower mold together, and rotating the mold to coat the ball material onto the inner surface of the mold and further be filled into the column holes; and opening the upper mold and the lower mold to take the bouncing ball out of the mold after the ball material is solidified.

### FIELD OF THE INVENTION

1. Field of the Invention

The present invention relates to a method for making a bouncing ball with a plurality of columns extending from an outer surface thereof.

2. The Prior Arts

Basketballs and footballs are generally made of rubber. These balls are inflated with air so as to make them have elasticity. Another bouncing ball similar to a toy ball is a solid elastic ball made of polyurethane (PU), which is elastic in nature so as to make the ball have elasticity. A further bouncing ball is a hollow ball and also made of polyurethane. The hollow bouncing ball may be, according to the desires, filled with liquid and/or ornaments inside of the ball, and further be painted with color patterns or be shaped with various contours on an inner surface of the ball for the purpose of decoration.

The PU material for use in making the bouncing ball is prepared by at least two liquid chemical materials in a specific ratio. The at least two liquid chemical materials are mixed to create a chemical reaction and be gradually solidified to be an elastic body. One of the conventional methods of making a hollow bouncing ball is to inject the PU material into a rotating mold, and the PU material is uniformly coated and solidified on an inner surface of the mold to form a hollow ball. The hollow ball is formed with a nozzle on a ball shell of the hollow ball by way of a protruded needle extending from the inner surface of the mold, so that air or liquid can be pumped into a hollow space of the ball via the nozzle. Then, a sealing plug is inserted in the nozzle for sealing. It should be noted that during solidification, the mold has to be continuously rotated to ensure that the PU material flows to everywhere in the mold so as to obtain a bouncing ball with a smooth surface.

Some bouncing balls have a plurality of columns extending from an outer surface thereof (see FIG. 1). Upon impact of the balls, these soft columns will deform so as to cause the balls to generate non-specifically directional bounce. The conventional method for making these bouncing balls with columns is to set a plurality of column holes extending outward from an inner surface of the mold for the bouncing ball. A liquid material for use in making the ball is filled into the mold and the mold is rotated to coat the liquid material onto the inner surface of the mold and further be filled into the column holes. After the liquid material is solidified, open the mold to take the bouncing ball out of the mold.

In general, the columns of the bouncing ball have a diameter of about 1-5 mm, and thus the column holes of the mold have a corresponding diameter thereto. In making the bouncing balls, since the liquid material is a sticky PU material which cannot be completely filled in each of the column holes of the mold, especially in a distal end thereof, the defective rate of making the bouncing balls is high. In order to improve the aforementioned disadvantage, the mold is equipped with an air hole extending outward from the distal end of the column holes of the mold. When the PU material flows into the column holes, the air in the column holes is released out through the air holes so that the PU material can be completely filled in the column holes of the mold. Nevertheless, some of the PU material will also flow into the air holes to form an edge flash at the distal end of the columns of the ball. To cut out the edge flash, more labor is required.

Thus, it is desired to provide a method for making a bouncing ball with columns, in which the columns are evenly formed without the edge flashes.

### SUMMARY OF THE INVENTION

A primary objective of the present invention is to provide a method for making a bouncing ball with columns, in which the columns are evenly formed without the edge flashes. In such a way, there is no need to cut out the edge flashes, so as to increase the production efficiency and reduce the production cost.

In order to achieve the above-mentioned objective, a technical solution of the present invention is to coat an air-permeable and liquid non-permeable material on an outer surface of the mold and thus cover on the column holes. In making a bouncing ball with the columns, the air inside the mold can be smoothly released out through the column holes and then the air-permeable and liquid non-permeable material. Furthermore, due to the blockage of the air-permeable and liquid non-permeable material, the ball material will not flow out the column holes. Therefore, a distal end of the columns of the ball will not have an edge flash, and thus there is no need to cut the edge flashes so as to save labor cost.

According to the present invention, a method for making a bouncing ball with columns includes the steps of: providing a mold comprising an upper mold and a lower mold each having a plurality of column holes extending outward from an inner surface thereof and being communicated with an outside of the mold, wherein an air-permeable and liquid non-permeable material is coated on an outer surface of the mold and thus covers the column holes; filling a ball material into the upper mold or the lower mold, coupling the upper mold and the lower mold together, and rotating the mold to coat the ball material onto the inner surface of the mold and further be filled into the column holes; and opening the upper mold and the lower mold to take the bouncing ball out of the mold after the ball material is solidified.

According to another embodiment of the present invention, at least one air hole is further provided at a distal end of each of the column holes and is in communication between the column hole and the outside of the mold. The diameter of the air hole is smaller than that of the column hole. The air-permeable and liquid non-permeable material is coated on the outer surface of each of the upper mold and the lower mold and thus covers the air holes. When the ball material is filled into the mold and the mold is rotated, the ball material is coated onto the inner surface of the mold and is further filled into the column holes. The air in the column holes will be released out through the air hole and the air-permeable and liquid non-permeable material. Because the ball material is sticky and the diameter of the air hole is relatively smaller than that of the column hole, only a relatively small amount of the ball material flows into the air hole so that the impact of the ball material on the air-permeable and liquid non-permeable material during rotating the mold is minimized.

According to an aspect of the present invention, the air-permeable and liquid non-permeable material is an air-permeable and water non-permeable tape.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a perspective view showing a bouncing ball made by a method according to the present invention;

FIG. 2 shows a semi-spherical upper mold and a semi-spherical lower mold for use in the method of the present invention;

FIG. 3 shows a cross sectional view of a mold in closed state, in which the ball material is coated onto an inner surface of the mold and further is filled into the column holes;

FIG. 4 is a locally enlarged cross sectional view of FIG. 3;

FIG. 5 shows semi-spherical upper and lower molds including air holes according to another embodiment of the present invention;

FIG. 6 shows a cross sectional view of a mold in closed state, in which the ball material is coated onto the inner surface of the mold and further is filled into the column holes and the air holes according to another embodiment of the present invention; and

FIG. 7 is a locally enlarged cross sectional view showing that the air in the column holes is released out through the air holes and the air-permeable material.

### DETAILED DESCRIPTION OF THE PREFERRED EMBODIMENT

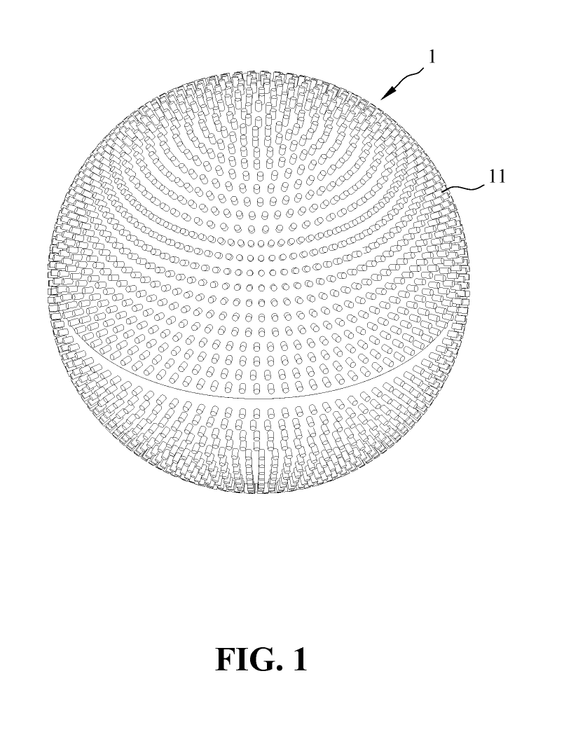

Referring to FIG. 1, which shows a bouncing ball 1 made by a method according to the present invention, the bouncing ball 1 includes a plurality of columns 11 extending from an outer surface of the bouncing ball 1. The bouncing ball 1 with the columns 11 is made of PU. Upon impact of the ball, these soft columns 11 will deform so as to cause the ball to generate non-specifically directional bounce.

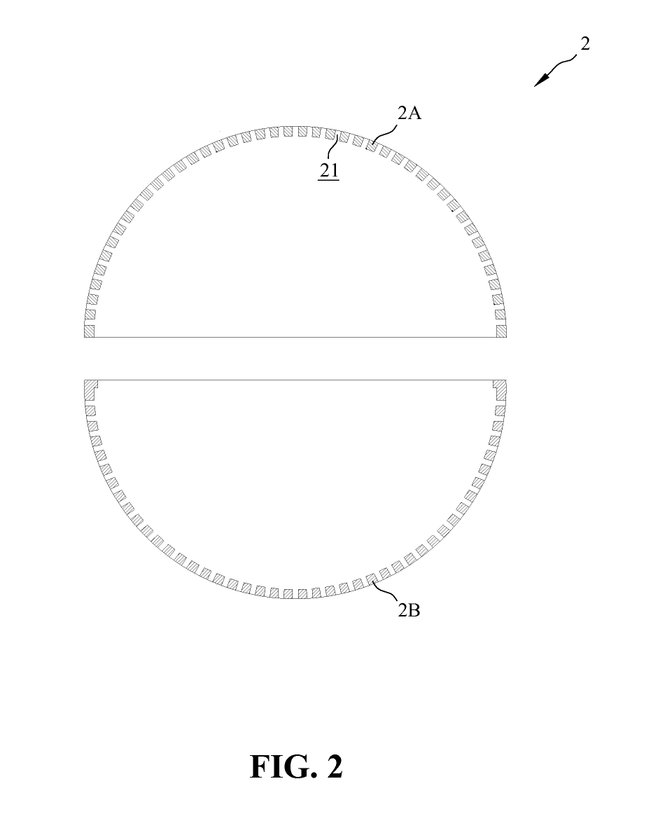

FIG. 2 shows a mold 2 for use in making the bouncing ball 1 with the plurality of columns 11 according to the method of the present invention. The mold 2 includes a semi-spherical upper mold 2A and a semi-spherical lower mold 2B that is coupled to the upper mold 2A to constitute the mold 2. Each of the upper mold 2A and the lower mold 2B has a plurality of column holes 21 extending outward from an inner surface thereof. The column holes 21 are communicated with an outside of the mold 2.

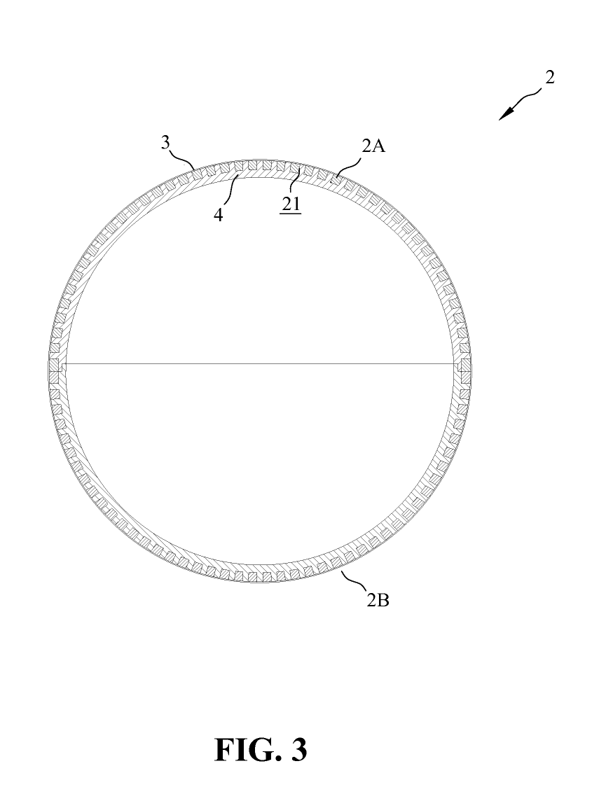

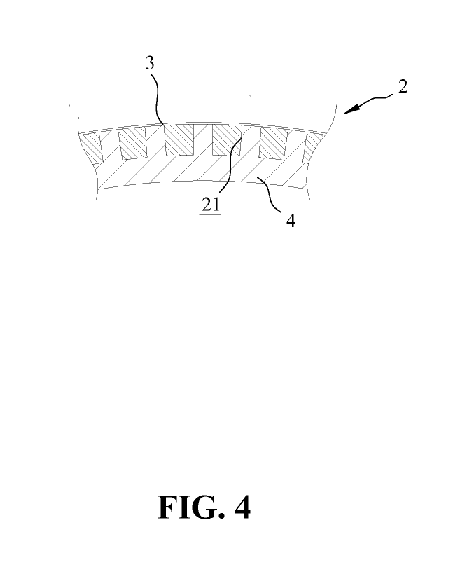

Referring to FIGS. 3 and 4, an air-permeable and liquid non-permeable material 3 is coated on the outer surface of each of the semi-spherical upper mold 2A and the semi-spherical lower mold 2B and thus covers the column holes 21. A ball material 4 is then filled into the semi-spherical upper mold 2A or the semi-spherical lower mold 2B. The semi-spherical upper mold 2A and the semi-spherical lower mold 2B are coupled together and the mold 2 is rotated by a machine (not shown) to coat the ball material 4 onto the inner surface of the mold 2 and further be filled into the column holes 21. After the ball material 4 is solidified, the upper and the lower molds 2A, 2B are then opened from each other, and the bouncing ball 1 with the columns 11 is taken out of the mold 2.

The air-permeable and liquid non-permeable material 3 allows air but disallows water or liquid molecular to pass therethrough. The air-permeable and liquid non-permeable material 3 can be a medical-grade tape or an industrial-grade tape. The air-permeable and liquid non-permeable material can be an air-permeable and water non-permeable tape.

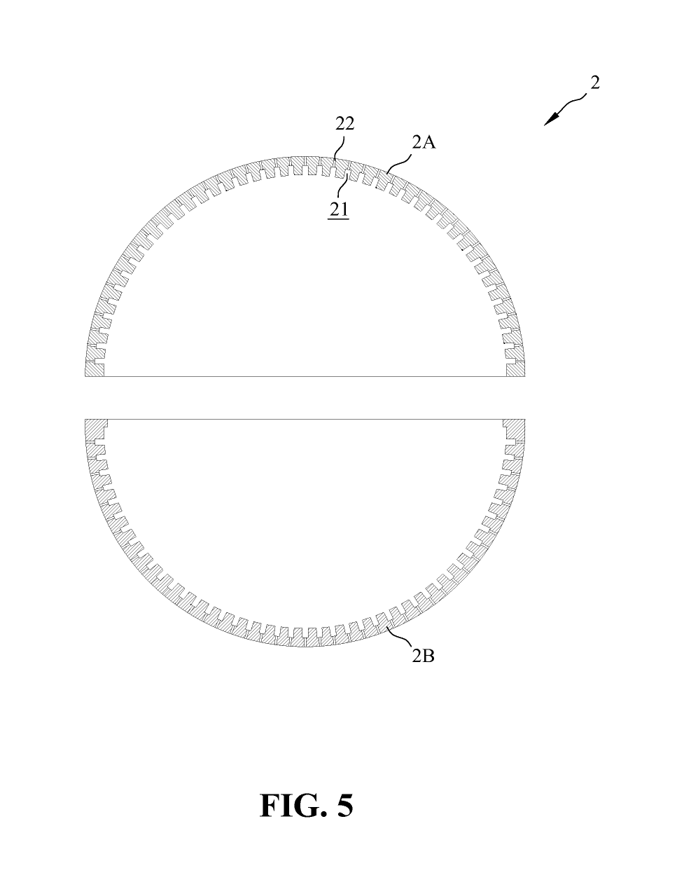

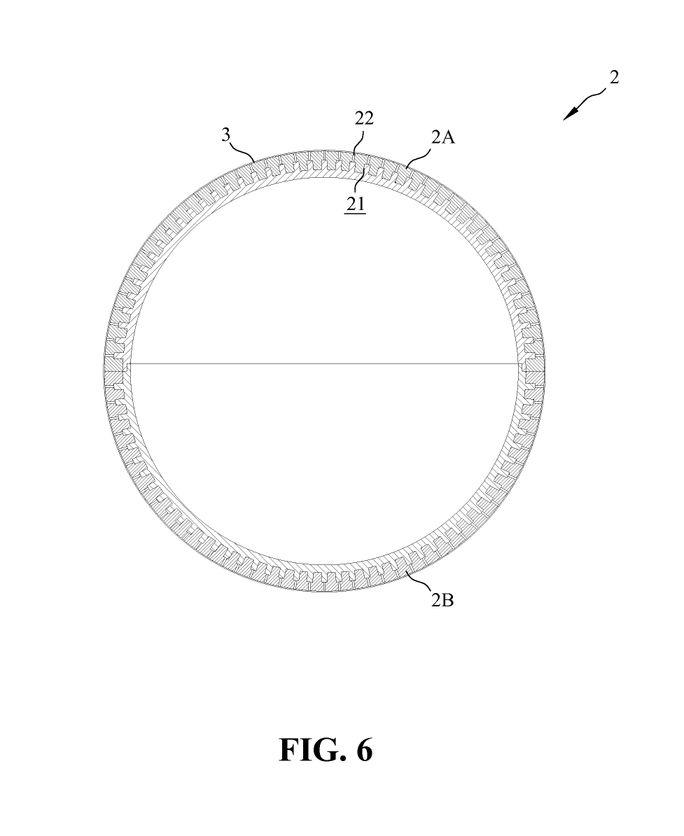

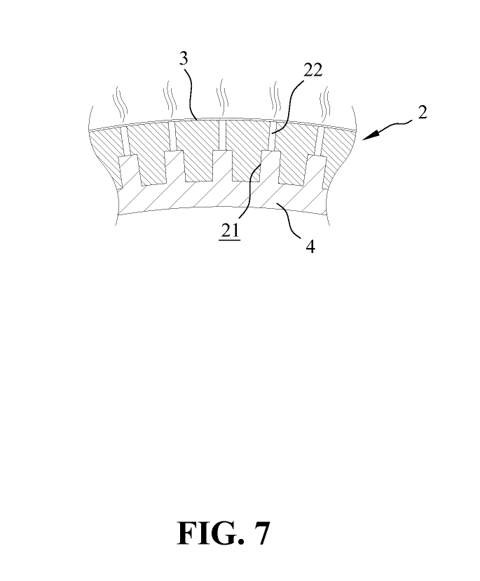

FIGS. 5 to 7 show another mold 2 for use in making a bouncing ball with the plurality of columns according to the method of the present invention. The mold 2 has a plurality of column holes 21 extending outward from an inner surface thereof. At least one air hole 22 is provided at a distal end of each of the column holes 21 and is in communication between the column hole 21 and the outside of the mold 2. The diameter of the air hole 22 is smaller than that of the column hole 21. In making a bouncing ball with the columns, an air-permeable and liquid non-permeable material 3 is coated on the outer surface of each of the semi-spherical upper mold 2A and the semi-spherical lower mold 2B and thus covers the air holes 22. A ball material 4 is filled into the semi-spherical upper mold 2A or the semi-spherical lower mold 2B. The semi-spherical upper mold 2A and the semi-spherical lower mold 2B are coupled together and the mold 2 is rotated by a machine (not shown) to coat the ball material 4 onto the inner surface of the mold 2 and further be filled into the column holes 21 and the air holes 22. After the ball material 4 is solidified, the upper and the lower molds 2A, 2B are then opened from each other, and the bouncing ball 1 with the columns 11 is taken out of the mold 2.

According to the embodiment of the present invention, when the mold 2 is rotated, the ball material 4 is coated onto the inner surface of the mold 2 and further is filled into the column holes 21. The air in the column holes 21 is released out through the air holes 22 and the air-permeable and liquid non-permeable material 3. Because the ball material 4 is sticky and the diameter of the air hole 22 is relatively smaller than that of the column hole 21, only a small amount of the ball material 4 flows into the air hole 22 so that the impact of the ball material 4 on the air-permeable and liquid non-permeable material 3 is minimized.

It should be noted that the method can also be used to make different shapes of the bouncing ball such as triangular body, rectangular body, or other polygonal body.

Although the detailed description of the invention has been directed to certain exemplary embodiments, various modifications of these embodiments, as well as alternative embodiments, will be suggested to those skilled in the art. The invention encompasses any modifications or alternative embodiments that fall within the scope of the claims.

What is claimed is:

1. A method for making a bouncing ball with columns, comprising:
providing a mold comprising an upper mold and a lower mold each having a plurality of column holes extending outward from an inner surface thereof and being communicated with an outside of the mold, wherein an air-permeable and liquid non-permeable material is coated on an outer surface of the mold and thus covers the column holes;
filling a ball material into the upper mold or the lower mold, coupling the upper mold and the lower mold together, and rotating the mold to coat the ball material onto the inner surface of the mold and further be filled into the column holes; and
opening the upper mold and the lower mold to take the bouncing ball out of the mold after the ball material is solidified.

2. The method as claimed in claim 1, wherein at least one air hole is provided at a distal end of each of the column holes and is in communication between the column hole and the outside of the mold, and the diameter of the air hole is smaller than that of the column holes, wherein the air-permeable and liquid non-permeable material is coated on an outer surface of the mold and thus covers the air holes.

3. The method as claimed in claim 1, wherein the air-permeable and liquid non-permeable material is an air-permeable and water non-permeable tape.
